(19) United States
(12) Patent Application Publication
(10) Pub. No.: US 2026/0145528 A1
(43) Pub. Date: May 28, 2026

(54) DISPLAY CONTROL DEVICE AND STORAGE MEDIUM

(71) Applicant: TOYOTA JIDOSHA KABUSHIKI KAISHA, Toyota-shi (JP)

(72) Inventor: Miki TSUJINO, Ichinomiya-shi (JP)

(73) Assignee: TOYOTA JIDOSHA KABUSHIKI KAISHA, Toyota-shi (JP)

(21) Appl. No.: 19/273,858

(22) Filed: Jul. 18, 2025

(30) Foreign Application Priority Data
Nov. 22, 2024 (JP) 2024-204257

(51) Int. Cl. B60K 35/29; B60K 35/23; B60K 35/28; B60K 35/81

(52) U.S. Cl. CPC B60K 35/29; B60K 35/23; B60K 35/28; B60K 35/81; B60K 2360/166; B60K 2360/176; B60K 2360/178; B60K 2360/1868

(57) ABSTRACT

The surrounding object or the lane is detected from the monitoring result of the surrounding situation monitoring device, and the host vehicle image depicting the host vehicle or the surrounding vehicle image depicting the surrounding vehicle is displayed, and the white line of the detected lane is displayed. At this time, when the current position is not on the expressway or the arterial road, the control to not display the white line of the lane is performed. Alternatively, in a case where the current position is a non-public road excluding the parking lot, the white line of the lane is not displayed.

### CROSS-REFERENCE TO RELATED APPLICATION

This application claims priority to Japanese Patent Application No. 2024-204257 filed on Nov. 22, 2024. The disclosure of the above-identified application, including the specification, drawings, and claims, is incorporated by reference herein in its entirety.

### BACKGROUND

### 1. Technical Field

The present disclosure relates to a display control device and a storage medium.

### 2. Description of Related Art

Japanese Unexamined Patent Application Publication No. 2022-041244 (JP 2022-041244 A) discloses a vehicle display device. The vehicle display device suppresses display of an image of a surrounding object other than a first preceding vehicle that travels ahead in a lane in which the host vehicle is traveling, on a head-up display (HUD), among images of surrounding objects for which information is acquired by an acquisition unit that acquires information on surrounding objects present around the host vehicle. On a meter display, the vehicle display device displays the first preceding vehicle, and displays the other surrounding objects by being toned down stepwise according to the importance.

### SUMMARY

A technique is known in which a white line of a lane detected by a camera is displayed as a periphery monitoring image. In the technique, the display on an expressway or an arterial road is mainly assumed. When the white line is displayed in an environment other than the expressway or the arterial road or on a non-public road, the white line may be displayed due to erroneous detection of objects other than the white line, and the occupant may feel uncomfortable. Therefore, there is room for improvement.

The present disclosure has been made in consideration of the above-described facts, and an object of the present disclosure is to provide a display control device and a display control program capable of suppressing a sense of discomfort given to an occupant when a periphery monitoring image is displayed.

A display control device according to a first aspect includes
an acquisition unit configured to acquire a detection result of a current position of a host vehicle and a detection result of a white line, and
a controller configured to display a host vehicle image depicting the host vehicle and display the white line based on the detection result of the white line acquired by the acquisition unit, and to control display such that the white line is not displayed when the current position is a road other than an expressway or an arterial road.

According to the first aspect, the acquisition unit acquires the detection result of the current position of the host vehicle and the detection result of the white line.

Then, the controller displays the host vehicle image depicting the host vehicle and displays the white line based on the detection result of the white line acquired by the acquisition unit, and controls the display such that the white line is not displayed when the current position is the road other than the expressway or the arterial road. As a result, since the white line is not displayed on the road other than the expressway or the arterial road, the display of the white line due to the erroneous detection is suppressed, and thus a sense of discomfort given to the occupant can be suppressed.

A display control device according to a second aspect includes
an acquisition unit configured to acquire a detection result of a current position of a host vehicle and a detection result of a white line, and
a controller configured to display a host vehicle image depicting the host vehicle and display the white line based on the detection result of the white line acquired by the acquisition unit, and to control display such that the white line is not displayed when the current position is a non-public road excluding a parking lot.

According to the second aspect, the acquisition unit acquires the detection result of the current position of the host vehicle and the detection result of the white line.

Then, the controller displays the host vehicle image depicting the host vehicle and displays the white line based on the detection result of the white line acquired by the acquisition unit, and controls the display such that the white line is not displayed when the current position is the non-public road excluding the parking lot. As a result, since the white line is not displayed on the non-public road excluding the parking lot, the display of the white line due to the erroneous detection is suppressed, and thus a sense of discomfort given to the occupant can be suppressed.

According to a third aspect, in the display control device of the first or second aspect, the controller is configured to permit a side-view display of the other vehicle with respect to the host vehicle when the white line is not displayed.

According to the third aspect, the erroneous display of the direction of the other vehicle in the periphery is suppressed, and thus a sense of discomfort given to the occupant can be suppressed.

A storage medium according to a fourth aspect stores a display control program that causes a computer to execute a process including
acquiring a detection result of a current position of a host vehicle and a detection result of a white line, and
displaying a host vehicle image depicting the host vehicle and displaying the white line based on the detection result of the white line that is acquired, and controlling display such that the white line is not displayed when the current position is a road other than an expressway or an arterial road.

According to the fourth aspect, it is possible to provide the storage medium storing the display control program capable of suppressing a sense of discomfort given to the occupant when the periphery monitoring image is displayed.

A storage medium according to a fifth aspect stores a display control program that causes a computer to execute a process including
acquiring a detection result of a current position of a host vehicle and a detection result of a white line, and
displaying a host vehicle image depicting the host vehicle and displaying the white line based on the detection result of the white line that is acquired, and controlling display such that the white line is not displayed when the current position is a non-public road excluding a parking lot.

According to the fifth aspect, it is possible to provide the storage medium storing the display control program capable of suppressing a sense of discomfort given to the occupant when the periphery monitoring image is displayed.

As described above, according to the present disclosure, it is possible to provide the display control device and the storage medium capable of suppressing a sense of discomfort given to the occupant when the periphery monitoring image is displayed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing an outline of an interior of a vehicle equipped with an in-vehicle device according to the present embodiment;

FIG. 2 is a block diagram showing a configuration of a control system of an in-vehicle device according to the present embodiment;

FIG. 3 is a block diagram showing a main electrical configuration of a meter ECU, a multimedia ECU, and an advanced driving assistance ECU in the in-vehicle device according to the present embodiment;

FIG. 4 is a diagram showing an example of the periphery monitoring display;

FIG. 5 is a functional block diagram showing a functional configuration of the multimedia ECU;

FIG. 6 is a flowchart showing an example of a flow of processing executed by the multimedia ECU of the in-vehicle device according to the present embodiment; and

FIG. 7 is a diagram showing an example of a side-view display of the surrounding vehicle image.

### DETAILED DESCRIPTION OF EMBODIMENTS

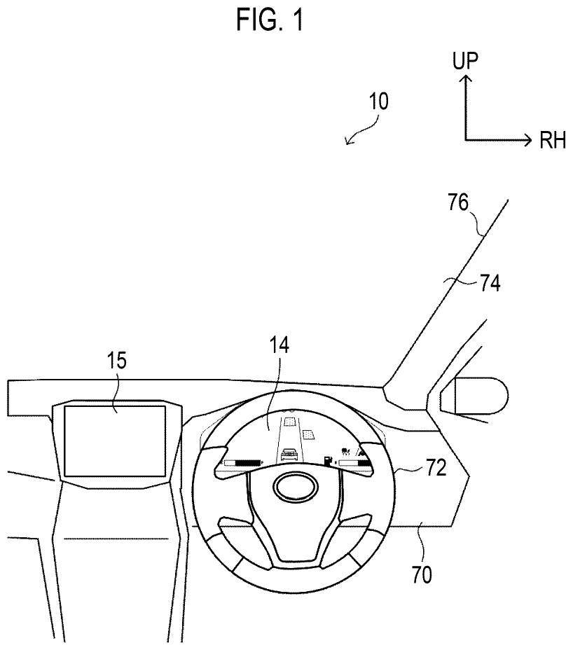

Hereinafter, an example of an embodiment of the present disclosure will be described in detail with reference to the drawings. FIG. 1 is a diagram showing an outline of an interior of a vehicle equipped with an in-vehicle device according to the present embodiment. The arrow UP shown in FIG. 1 indicates an upper side in the vehicle vertical direction, and the arrow RH indicates a right side in the vehicle width direction. In the following description, an up-down direction and a right-left direction mean, respectively, an up-down of the vehicle vertical direction and a right-left of the vehicle width direction.

As shown in FIG. 1, an instrument panel 70 is provided at a front portion of a vehicle cabin inside the vehicle 10. A windshield glass 74 is provided at a front end portion of the instrument panel 70. The windshield glass 74 extends in a vehicle vertical direction and a vehicle width direction to partition the inside of the vehicle cabin and the outside of the vehicle cabin.

A vehicle right end portion of the windshield glass 74 is fixed to a front pillar 76 on the vehicle right side. The front pillar 76 extends in the vehicle vertical direction, and the windshield glass 74 is fixed to an inner end portion of the front pillar 76 in the vehicle width direction. The vehicle left end portion of the windshield glass 74 is fixed to a front pillar on the vehicle left side (not shown).

The instrument panel 70 extends in a vehicle width direction, and a steering wheel 72 is provided on a vehicle right side of the instrument panel 70. That is, in the present embodiment, as an example, a right-hand drive vehicle in which the steering wheel 72 is provided on the right side is used, and the driver's seat is set on the right side of the vehicle.

The display 14 is provided at a position corresponding to the front of the steering wheel 72 of the instrument panel 70, and the multimedia display 15 is provided at the center of the instrument panel 70. The display 14 and the multimedia display 15 are configured by a touch panel including a liquid crystal, for example, and display a traveling state of the vehicle, an operation situation of a driving assistance device, and the like, and receive a touch operation.

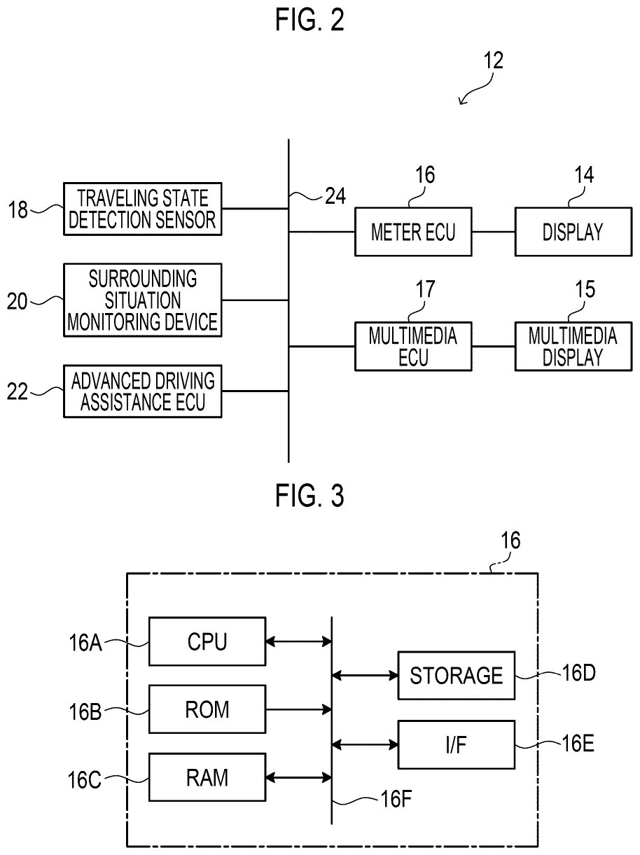

Next, a configuration of a control system of the in-vehicle device 12 according to the present embodiment will be described. FIG. 2 is a block diagram showing a configuration of a control system of the in-vehicle device 12 according to the present embodiment.

The in-vehicle device 12 according to the present embodiment includes a meter electronic control unit (ECU) 16 as an example of a display control device, a multimedia ECU 17 as another example of the display control device, a traveling state detection sensor 18, a surrounding situation monitoring device 20, an advanced driving assistance ECU 22, and the like. The meter ECU 16, the multimedia ECU 17, the traveling state detection sensor 18, the surrounding situation monitoring device 20, the advanced driving assistance ECU 22, and the like are connected to the vehicle network 24, respectively.

The display 14 is connected to the meter ECU 16, and the meter ECU 16 performs a process of displaying a plurality of meters by controlling the display 14, a process of displaying a monitoring result around the vehicle, various pieces of information of the vehicle, and the like. In addition, when an abnormality in the vehicle or the like occurs, the meter ECU 16 displays the occurrence of the abnormality on the display 14 to notify the occupant. Examples of various pieces of information of the vehicle displayed on the display 14 include an operation situation of a driving assistance device. A display mode of the display 14 can be switched by a switch (not shown) or the like, and can be changed to a display mode according to a preference of a driver.

The multimedia ECU 17 is connected to the multimedia display 15, and controls the multimedia display 15 to execute a process of displaying information such as the monitoring result around the vehicle, a map image, and a setting screen of various functions of the vehicle.

The traveling state detection sensor 18 detects a traveling state of the vehicle 10. As the traveling state detection sensor 18, for example, at least one of various sensors such as a vehicle speed sensor, an acceleration sensor, a gyro sensor, an accelerator operation amount sensor, and a brake sensor is included.

The surrounding situation monitoring device 20 detects information indicating what kind of situation the surrounding environment of the host vehicle is in. For example, the device includes at least one of various devices, such as a global positioning system (GPS) device, an in-vehicle communication device, a navigation system, a radar device, an ultrasonic sensor, and a camera.

The advanced driving assistance ECU 22 acquires the peripheral information detected by the surrounding situation monitoring device 20 that monitors the periphery, and has a function of providing the peripheral information to other ECUs or controlling the steering or the brake when needed. The advanced driving assistance ECU 22 executes processing of controlling the brake to assist in deceleration, for example, in a case where the accelerator-off is detected by the traveling state detection sensor 18 and the front vehicle, the intersection, or the like is detected by the surrounding situation monitoring device 20. Specifically, the advanced driving assistance ECU 22 controls various driving assistance functions, such as an adaptive cruise control function, a lane tracing assist function, and a lane change assist function. The adaptive cruise control is a function of controlling acceleration and deceleration by following a preceding vehicle according to a change in vehicle speed of the preceding vehicle. The lane tracing assist function is a function of issuing a warning of a possibility of deviation from a lane or a track and assisting a part of a steering operation for avoiding the deviation from the lane or the track. The lane change assist function is a function of assisting a part of a steering operation needed for a lane change. The preceding vehicle following function is not limited to the adaptive cruise control function, and may be another preceding vehicle following function. In addition, the lane change function is not limited to the lane change assist function, and may be another lane change function. Further, the driving assistance function is not limited to the above, and various other driving assistance functions may be applied.

FIG. 3 is a block diagram showing main electrical configurations of the meter ECU 16, the multimedia ECU 17, and the advanced driving assistance ECU 22 in the in-vehicle device 12 according to the present embodiment. The meter ECU 16, the multimedia ECU 17, and the advanced driving assistance ECU 22 are basically configured as a general computer. Therefore, here, the meter ECU 16 will be described as a representative. The multimedia ECU 17 and the advanced driving assistance ECU 22 have the same configuration as the meter ECU 16 shown in FIG. 3.

The meter ECU 16 is configured by a general microcomputer including a central processing unit (CPU) 16A, a read only memory (ROM) 16B, a random access memory (RAM) 16C, a storage 16D, an interface (I/F) 16E, a bus 16F, and the like.

The CPU 16A is a central processing unit that executes various programs to control the overall operation of the device. The ROM 16B stores various control programs, various parameters, and the like, such as a display control program in advance. The RAM 16C is used as a work area or the like when various programs are executed by the CPU 16A. The storage 16D is constituted of various storage units, such as a hard disk drive (HDD), a solid state drive (SSD), and a flash memory, and stores various data, application programs, and the like. The I/F 16E can be connected to the vehicle network 24, and transmits and receives various data to and from other ECUs, such as the meter ECU 16, connected to the vehicle network 24. The above-described units of the meter ECU 16 are electrically connected to each other by the bus 16F. In the present embodiment, the display control program is described as being stored in the ROM 16B, but may be stored in the storage 16D.

In the present embodiment, at least one of the display 14 and the multimedia display 15 can display the vehicle situation in the vicinity of the vehicle by a situation awareness (SA) view display (periphery monitoring display). In the periphery monitoring display, the surrounding situation of the host vehicle is notified to the occupant by displaying the host vehicle image depicting the host vehicle and displaying the object image. The object image represents an object (for example, another vehicle such as a surrounding vehicle including a preceding vehicle) present in the vicinity of the host vehicle detected by the traveling state detection sensor 18 or the surrounding situation monitoring device 20.

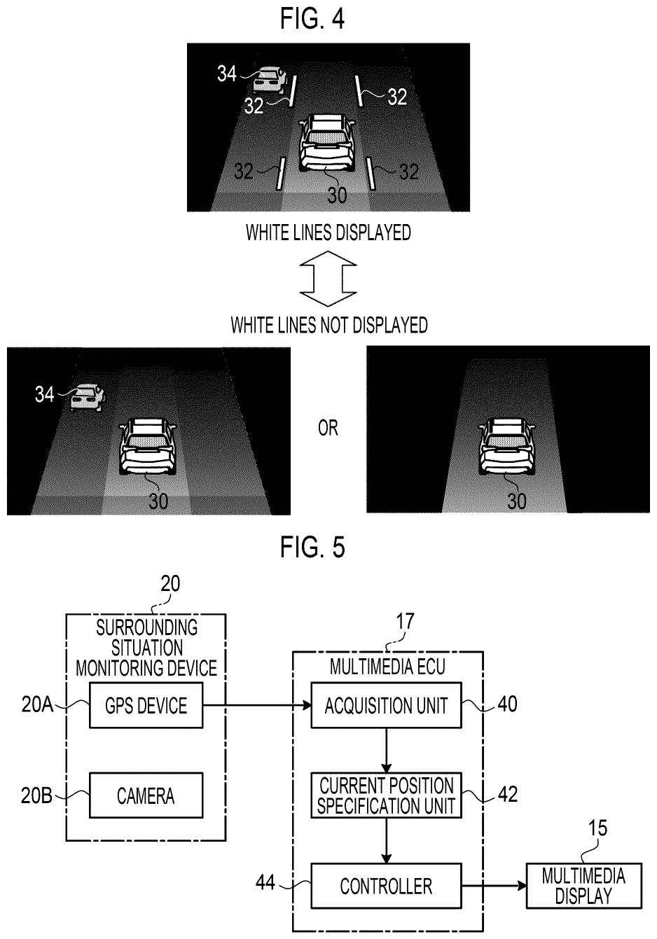

In the periphery monitoring display described above, the surrounding object or the lane is detected from the monitoring result of the surrounding situation monitoring device 20, and as shown in the upper side of FIG. 4, the host vehicle image 30 depicting the host vehicle or the surrounding vehicle image 34 depicting the surrounding vehicle is displayed, and the white line 32 of the detected lane is displayed. The surrounding vehicle is displayed based on information from an ultrasonic sensor, such as a clearance sonar, as the surrounding situation monitoring device 20, and the white line 32 is displayed based on a captured image of a camera as the surrounding situation monitoring device. FIG. 4 is a diagram showing an example of the periphery monitoring display.

However, depending on a place during traveling, such as a place other than an expressway or an arterial road or a non-public road, the display of the white line 32 of the lane displayed in the periphery monitoring image may be unnatural. For example, a white stone or the like may be erroneously detected as a white line, and the white line 32 may be displayed.

Therefore, in the in-vehicle device 12 according to the present embodiment, when the current position is not the expressway or the arterial road, the control to not display the white line 32 of the lane is performed. Alternatively, when the current position is a non-public road excluding the parking lot, the control to not display the white line 32 of the lane is performed. For example, as shown in the lower side of FIG. 4, the white line 32 is not displayed. At this time, as shown on the left side of the lower side of FIG. 4, the area of the gray line depicting the road on which the surrounding vehicle image 34 travels may be left as the gray line, or as shown on the right side of the lower side of FIG. 4, the gray line may be blurred. In the following, a case where the white line 32 is not displayed in a case other than the expressway or the arterial road will be described as an example. In the present disclosure, the expressway includes an automobile road and a road exclusively for motor vehicles. In addition, the expressway may be replaced with a high-standard arterial road. In addition, the arterial road refers to a road that connects main areas in Japan, such as a high-speed motorway, and other general national highways and prefectural roads, including the general national highways and prefectural roads, which constitute the foundation of the road traffic network. In addition, the public road refers to a road provided for the use of the public, and the non-public road refers to a road other than the public road, such as a private road that is privately owned and used.

Here, a functional configuration in which at least one of the CPUs 16A, 17A of the meter ECU 16 and the multimedia ECU 17 that perform the periphery monitoring display functions by executing the program stored in the ROMs 16B, 17B will be described. Since the functional configurations of the meter ECU 16 and the multimedia ECU 17 are the same, the following description will be made with the multimedia ECU 17 as a representative. FIG. 5 is a functional block diagram showing a functional configuration of the multimedia ECU 17.

As shown in FIG. 5, the multimedia ECU 17 has functions of the acquisition unit 40, the current position specification unit 42, and the controller 44 by the CPU 17A executing a program stored in the ROM 17B.

The acquisition unit 40 acquires the detection result of the surrounding situation monitoring device 20. For example, the position information of the host vehicle detected by the GPS device 20A of the surrounding situation monitoring device 20, the captured image around the host vehicle captured by the camera 20B, or the like is acquired.

The current position specification unit 42 specifies the current position from the position information of the host vehicle acquired by the acquisition unit 40. For example, the place of the current position is specified from navigation information, such as map information of the navigation device, or a captured image of the camera 20B. In the present embodiment, the current traveling place is specified as a place other than the expressway or the arterial road, a non-public road, or the like. Specifically, the departure from the expressway or the arterial road or the public road may be determined by determining the navigation information or the progress to the outside of the lane from the captured image of the camera 20B. For example, in a case where the vehicle enters the premises on the navigation, in a case where the vehicle crosses the sidewalk, or in a case where the vehicle crosses the lane, the vehicle may be determined to be departing from the expressway, the arterial road, or the public road.

The controller 44 causes the periphery monitoring image to be displayed on the multimedia display 15 together with the host vehicle image 30 based on the detection result of the surrounding object of the vehicle 10 detected by the surrounding situation monitoring device 20. For example, as shown in the upper side of FIG. 4, the host vehicle image 30 is displayed, and the surrounding vehicle image 34 or the white line 32 of the lane is displayed as the periphery monitoring image.

In addition, the controller 44 controls the display of the white line 32 based on the specification result of the current position specification unit 42. Specifically, the controller 44 ignores the detection of the white line 32 and controls the display on the multimedia display 15 such that the white line 32 is not displayed when the specified current position is not the expressway or the arterial road or when the specified current position is the non-public road. When the parking lot is detected by the navigation information, the detection of the parking space, or the like, the lane display or the parking space display is restarted.

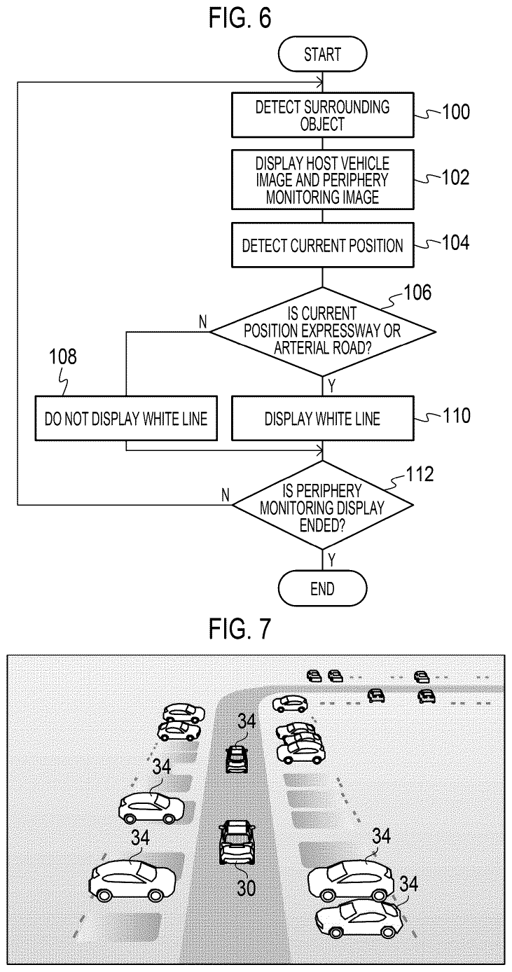

Next, processing executed by the multimedia ECU 17 of the in-vehicle device 12 according to the present embodiment configured as described above will be described. FIG. 6 is a flowchart showing an example of a flow of processing executed by the multimedia ECU 17 of the in-vehicle device 12 according to the present embodiment. The process of FIG. 6 is started, for example, when a predetermined operation for starting the periphery monitoring display is performed. In addition, in the following, the processing of FIG. 8 will be described as the processing performed by the multimedia ECU 17, but may be the processing performed by the meter ECU 16.

In step 100, the CPU 17A detects the surrounding object and proceeds to step 102. In the present embodiment, the surrounding object including the white line 32 is detected by acquiring the detection result of the traveling state detection sensor 18 or the detection result of the surrounding situation monitoring device 20.

In step 102, the CPU 17A displays the host vehicle image 30 and the periphery monitoring image on the multimedia display 15 and proceeds to step 104. For example, as shown in the upper side of FIG. 4, the host vehicle image 30 is displayed, and the periphery monitoring display is performed by displaying the surrounding vehicle image 34 or the object image such as the white line 32 of the lane as the periphery monitoring image.

In step 104, the CPU 17A detects the current position and proceeds to step 106. That is, the position information of the host vehicle of the GPS device 20A of the surrounding situation monitoring device 20 acquired by the acquisition unit 40 is detected as the current position, and the place of the current position is specified from the navigation information, such as the map information of the navigation device.

In step 106, the CPU 17A determines whether the current position is an expressway or an arterial road. When the determination is negative, the process proceeds to step 108, and when the determination is positive, the process proceeds to step 110. The step 106 may be a step of the CPU 17A determining whether the current position is a non-public road, and proceeding to step 108 in a case of the positive determination and proceeding to step 110 in a case of a negative determination.

In step 108, the CPU 17A does not display the white line 32 and proceeds to step 112. That is, the controller 44 controls the display on the multimedia display 15 such that the white line 32 detected in step 100 is not displayed. When the current position is the parking lot, a white line such as a lane in the parking lot or a frame line of a parking space is displayed.

On the other hand, in step 110, the CPU 17A displays the white line 32 and proceeds to step 112. The controller 44 controls the display on the multimedia display 15 such that the white line 32 is not displayed. As a result, a sense of discomfort due to the display of the white line 32 erroneously detected in a place other than the expressway or the arterial road can be suppressed.

In step 112, the CPU 17A determines whether to end the periphery monitoring display. For example, the CPU 17A determines whether an operation to end the periphery monitoring display is performed. Alternatively, the CPU 17A determines whether an instruction to operate another function, such as an air conditioning operation or an audio operation, is performed. When the determination is negative, the process returns to step 100 to repeat the above-described process, and when the determination is positive, the series of processes is terminated.

In the above-described embodiment, when the surrounding vehicle image 34 is displayed as the periphery monitoring image in step 102, the surrounding vehicles are often traveling in the same direction (vertical direction) as the host vehicle. Therefore, when the surrounding vehicle is detected and the surrounding vehicle image 34 is displayed, the side-view display of the surrounding vehicle image 34 may be prohibited.

When the side-view display of the surrounding vehicle image 34 is prohibited, the current position is highly likely to be a place other than the expressway or the arterial road, or a non-public road, and the surrounding vehicle is highly likely to be lateral to the host vehicle, such as a parking lot. Therefore, in a case where the white line 32 is not displayed (in a case where the current position is a place other than the expressway or the arterial road, or in a case where the current position is a non-public road), as shown in FIG. 7, the side-view display of the surrounding vehicle image 34 with respect to the host vehicle image 30 may be permitted. As a result, the user discomfort can be suppressed.

In the above-described embodiment, an example has been described in which the periphery monitoring display is made possible on at least one of the display 14 and the multimedia display 15, but the present disclosure is not limited thereto. For example, the periphery monitoring display may be performed on a head-up display (HUD) to accept the operation on the peripheral monitoring display.

In the above-described embodiment, the display 14 is controlled by the meter ECU 16, and the multimedia display 15 is controlled by the multimedia ECU 17. However, the present disclosure is not limited thereto. For example, the display 14 and the multimedia display 15 may be controlled by one ECU.

The processing executed by the multimedia ECU 17 in each of the above embodiments has been described as software processing executed by executing a program, but the present disclosure is not limited thereto. For example, the processing may be performed by hardware, such as a graphics processing unit (GPU), an application specific integrated circuit (ASIC), or a field-programmable gate array (FPGA). Alternatively, the processing may be a combination of both software and hardware. In addition, in a case where the processing is performed by software, the program may be stored in various storage media and distributed.

Further, the present disclosure is not limited to the above, and can be variously modified and implemented within the scope of the spirit of the present disclosure.

What is claimed is:

1. A display control device comprising:
an acquisition unit configured to acquire a detection result of a current position of a host vehicle and a detection result of a white line; and
a controller configured to display a host vehicle image depicting the host vehicle and display the white line based on the detection result of the white line acquired by the acquisition unit, and to control display such that the white line is not displayed when the current position is a road other than an expressway or an arterial road.

2. A display control device comprising:
an acquisition unit configured to acquire a detection result of a current position of a host vehicle and a detection result of a white line; and
a controller configured to display a host vehicle image depicting the host vehicle and display the white line based on the detection result of the white line acquired by the acquisition unit, and to control display such that the white line is not displayed when the current position is a non-public road excluding a parking lot.

3. The display control device according to claim 1, wherein:
the acquisition unit is configured to further acquire a detection result of another vehicle around the host vehicle; and
the controller is configured to display the other vehicle based on the detection result of the other vehicle and permit a side-view display of the other vehicle with respect to the host vehicle when the white line is not displayed.

4. The display control device according to claim 2, wherein:
the acquisition unit is configured to further acquire a detection result of another vehicle around the host vehicle; and
the controller is configured to display the other vehicle based on the detection result of the other vehicle and permit a side-view display of the other vehicle with respect to the host vehicle when the white line is not displayed.

5. A non-transitory storage medium storing a display control program that causes a computer to execute a process comprising:
acquiring a detection result of a current position of a host vehicle and a detection result of a white line; and
displaying a host vehicle image depicting the host vehicle and displaying the white line based on the detection result of the white line that is acquired, and controlling display such that the white line is not displayed when the current position is a road other than an expressway or an arterial road.
